(19) United States
(12) Patent Application Publication
(10) Pub. No.: US 2026/0264833 A1
(43) Pub. Date: Sep. 10, 2026

(54) High Altitude Balloon Phase Change Ballasting System

(71) Applicant: MACH Industries Inc., Huntington Beach, CA (US)

(72) Inventors: Craig John Smith, Laguna Niguel, CA (US); Robert James Douglas Siddall, Long Beach, CA (US); Max Legare Balasubramaniam, Westminister, CA (US)

(21) Appl. No.: 19/555,517

(22) Filed: Mar. 3, 2026

Related U.S. Application Data
(60) Provisional application No. 63/767,469, filed on Mar. 5, 2025.

(51) Int. Cl. B64B 1/70; B64B 1/40; B64B 1/60; B64D 45/00; G05D 1/48; G05D 109/20

(52) U.S. Cl. CPC B64B 1/70; B64B 1/40; B64B 1/60; B64D 45/00; G05D 1/48; G05D 2109/26

(57) ABSTRACT

A high-altitude balloon system configured to maintain an altitude across environmental conditions by controlling phase changes of a multi-phase ballast gas. The high-altitude balloon system comprises a balloon, comprising a gas, wherein an environmental condition affecting a pressure of the gas within the balloon; and a ballast component, fluidically coupled to the balloon. The ballast component comprising: a tank, coupled to the balloon, the tank comprising the multi-phase ballast gas in a liquid phase; an environmental sensor, coupled to the tank; and a controller, coupled to the environmental sensor. The controller configured to: detect the environmental condition affecting the balloon; determine the pressure changes from an initial pressure to a modified pressure; and control a phase change of the multi-phase ballast gas to change the pressure from the modified pressure to a compensated pressure, wherein the phase change causes the multi-phase ballast gas to adjust the compensated pressure.

### CROSS REFERENCE TO RELATED APPLICATION

This application claims the benefit of U.S. Provisional Application No. 63/767,469 filed Mar. 5, 2025, the content of which is incorporated by reference herein in its entirety.

### BACKGROUND

High-altitude balloons have been in use for many decades for various purposes. Most commonly to collect data on ascent to stratospheric levels where they burst and the payload returns to the ground a few hours later. However if you can 1) float a balloon for multiple days, and 2) navigate the balloon by controlling the altitude to various wind layers, this substantially opens the viable use cases for a high-altitude balloon as it can now be navigated with reasonable precision an aerial payload at a much lower cost per aerial hour than an airplane or even low earth orbit cube satellites.

Typical high-altitude balloons are filled with helium or hydrogen as the lifting gas which is about 7% of the density of air, to a determined volume suitable to lift the attached payload. Most common weather balloons are then released and ascend up to 100,000 ft within a couple hours, at which point they burst. If it's desired to extend the time a balloon can stay aloft, then a venter can be added to a balloon to bleed off helium when the balloon reaches a desired altitude. This will arrest the ascent and enable the balloon to stay at a given altitude prior to bursting. However, the problem comes between day and night as the temperature drastically changes. During night the gas compresses with colder temps and the balloon will drop considerably in altitude, the next day as the sun comes up the balloon will ascend again.

If the desire is to navigate the balloon by keeping it at a certain altitude conducive to wind, the temperature swing between night and day will ascend and descend the balloon through various wind streams making it very difficult to navigate through a night/day cycle.

### TECHNICAL FIELD

The technical field of the disclosure is a high-altitude balloon to maintain an altitude across environmental conditions by controlling phase changes of a multi-phase ballast gas.

### SUMMARY

In some aspects, the techniques described herein relate to a method including: detecting an environmental condition affecting a high-altitude balloon, the environmental condition affecting a pressure within the high-altitude balloon; responsive to detecting the environmental condition, determining the pressure changes from an initial pressure to a modified pressure; and controlling a phase change of a multi-phase ballast gas to change the pressure from the modified pressure to a compensated pressure, wherein the phase change causes the multi-phase ballast gas to adjust the compensated pressure towards the initial pressure.

In some aspects, the techniques described herein relate to a method, further including adjusting an altitude of the high-altitude balloon towards a target altitude by controlling the phase change of the multi-phase ballast gas.

In some aspects, the techniques described herein relate to a method, wherein adjusting the altitude of the high-altitude balloon includes, responsive to temperature changes, adjusting the altitude of the high-altitude balloon towards the target altitude by controlling the phase change of the multi-phase ballast gas.

In some aspects, the techniques described herein relate to a method, further including, responsive to a temperature decrease, causing the phase change to expel the multi-phase ballast gas from a ballast tank to achieve the target altitude.

In some aspects, the techniques described herein relate to a method, wherein the high-altitude balloon includes a first balloon and a second balloon, wherein controlling the phase change of the multi-phase ballast gas includes controlling the phase change of the multi-phase ballast gas to change the modified pressure in the second balloon.

In some aspects, the techniques described herein relate to a method, wherein the second balloon is within the first balloon.

In some aspects, the techniques described herein relate to a method, wherein the second balloon is outside of the first balloon.

In some aspects, the techniques described herein relate to a method, wherein the high-altitude balloon includes a single balloon, wherein controlling the phase change of the multi-phase ballast gas includes controlling the phase change of the multi-phase ballast gas to change the modified pressure in the single balloon.

In some aspects, the techniques described herein relate to a method, wherein controlling the phase change includes extracting the multi-phase ballast gas from the high-altitude balloon.

In some aspects, the techniques described herein relate to a method, wherein controlling the phase change includes: measuring a total volume of gas in the high-altitude balloon, wherein the total volume of gas includes a target volume for the multi-phase ballast gas; and controlling the multi-phase ballast gas to achieve the target volume being between about 10% and about 25% of the total volume of gas.

In some aspects, the techniques described herein relate to a high-altitude balloon system configured to maintain an altitude across environmental conditions by controlling phase changes of a multi-phase ballast gas, the high-altitude balloon system including: a balloon, including a gas, wherein an environmental condition affecting a pressure of the gas within the balloon; and a ballast component, fluidically coupled to the balloon, the ballast component including: a tank, coupled to the balloon, the tank including the multi-phase ballast gas in a liquid phase; an environmental sensor, coupled to the tank, configured to measure the environmental condition; and a controller, coupled to the environmental sensor, the controller configured to: detect the environmental condition affecting the balloon; responsive to detecting the environmental condition, determine the pressure changes from an initial pressure to a modified pressure; and control a phase change of the multi-phase ballast gas to change the pressure from the modified pressure to a compensated pressure, wherein the phase change causes the multi-phase ballast gas to adjust the compensated pressure towards the initial pressure.

In some aspects, the techniques described herein relate to a high-altitude balloon system, wherein the controller is further configured to adjust an altitude of the high-altitude balloon system towards a target altitude by controlling the phase change of the multi-phase ballast gas.

In some aspects, the techniques described herein relate to a high-altitude balloon system, wherein the controller is further configured to, responsive to temperature changes, adjust the altitude of the high-altitude balloon system towards the target altitude by controlling the phase change of the multi-phase ballast gas.

In some aspects, the techniques described herein relate to a high-altitude balloon system, wherein the controller is further configured to, responsive to a temperature decrease, expel the multi-phase ballast gas from the tank to achieve the target altitude.

In some aspects, the techniques described herein relate to a high-altitude balloon system, wherein the balloon includes a first balloon and a second balloon, wherein the controller is further configured to control the phase change of the multi-phase ballast gas to change the modified pressure in the second balloon.

In some aspects, the techniques described herein relate to a high-altitude balloon system, wherein the second balloon is within the first balloon.

In some aspects, the techniques described herein relate to a high-altitude balloon system, wherein the second balloon is outside of the first balloon.

In some aspects, the techniques described herein relate to a high-altitude balloon system, wherein the balloon includes a single balloon, wherein the controller is further configured to control the phase change of the multi-phase ballast gas to change the modified pressure in the single balloon.

In some aspects, the techniques described herein relate to a high-altitude balloon system, wherein the controller is further configured to: measure a total volume of gas in the balloon, wherein the total volume of gas includes a target volume for the multi-phase ballast gas; and control the multi-phase ballast gas to achieve the target volume being between about 10% and about 25% of the total volume of gas.

In some aspects, the techniques described herein relate to a non-transitory computer-readable medium, storing computer program instructions that, when executed by a processor, cause the processor to: detect an environmental condition affecting a high-altitude balloon, the environmental condition affecting a pressure within the high-altitude balloon; responsive to detecting the environmental condition, determine the pressure changes from an initial pressure to a modified pressure; and control a phase change of a multi-phase ballast gas to change the pressure from the modified pressure to a compensated pressure, wherein the phase change causes the multi-phase ballast gas to adjust the compensated pressure towards the initial pressure.

### BRIEF DESCRIPTION OF THE DRAWINGS

FIG. 1 illustrates a perspective view of the balloon system, according to one or more aspects herein.

FIGS. 2A-2B illustrate various perspective views of the balloon system, according to one or more aspects herein.

FIG. 2C illustrates a system architecture implemented by the balloon system, according to one or more aspects herein.

FIGS. 3A-3B illustrate example fluidic diagrams of the balloon system, according to one or more aspects herein.

FIG. 4 illustrates an example block diagram for controlling a phase change of multi-phase ballast gas, according to one or more aspects herein.

FIGS. 5A-5C illustrate example pictures of the balloon system, according to one or more aspects herein.

FIG. 6A illustrates a perspective view of the balloon system, according to one or more aspects herein.

FIG. 6B illustrates a close-up perspective view of a chassis of the balloon system, according to one or more aspects herein.

FIG. 7 is a networking environment of a balloon system, according to one or more aspects herein.

FIG. 8 is an illustrative diagram of controlling the flight of a balloon system, according to one or more aspects herein.

FIG. 9 is an illustrative diagram of controlling the trajectory of the balloon system by altitude manipulation, according to one or more aspects herein.

FIG. 10 shows plots in one example flight of a navigable balloon system, according to one or more aspects herein.

FIG. 11 is a picture of a balloon system, according to one or more aspects herein.

FIG. 12 is a system architecture implemented by the balloon system for balloon navigation, according to one or more aspects herein.

FIG. 13 illustrates a computing environment for implementing the approaches described herein, according to one or more aspects herein s.

The figures depict, and the detail description describes, various non-limiting aspects herein for purposes of illustration only.

### DETAILED DESCRIPTION

The figures (FIGs.) and the following description relate to preferred aspects herein by way of illustration only. One of skill in the art may recognize alternative aspects herein of the structures and methods disclosed herein as viable alternatives that may be employed without departing from the principles of what is disclosed.

Reference will now be made in detail to several aspects herein, examples of which are illustrated in the accompanying figures. It is noted that wherever practicable similar or like reference numbers may be used in the figures and may indicate similar or like functionality. The figures depict aspects of the disclosed system (or method) for purposes of illustration only. One skilled in the art will readily recognize from the following description that alternative aspects of the structures and methods illustrated herein may be employed without departing from the principles described herein.

### Configuration Overview

Aspects described herein relate to a high-altitude balloon with capabilities to perform an automatic environment response to offset altitude changes caused by environmental conditions (for example, maintaining a desired flight level between night and daytime temperature swings). The high-altitude balloon may be filled with a fill gas. The fill gas includes a lift gas and a multi-phase ballast gas. The lift gas may be helium, hydrogen, and/or the like. The multi-phase ballast gas may be ammonia or a different multi-phase ballast gas. In some cases, the fill gas may be about 90% lift gas and about 10% multi-phase ballast gas.

The multi-phase ballast gas (e.g., ammonia) is less dense than air and provides positive buoyancy as a gas in the balloon, although not as much as hydrogen or helium. When the balloon reaches high altitudes and cold environment, the multi-phase ballast gas does not require much pressure to compress into a liquid form. The multi-phase ballast gas which sits in the bottom of the balloon can be compressed into a container as a liquid below the balloon. For example, the multi-phase ballast gas may be stored in a ballast tank that hangs from the balloon. This in turn lowers the altitude as now the liquid has a negative buoyancy effect. However, the liquid can be vented back into the balloon. For example, at low atmospheric pressure multi-phase ballast gas can convert back to a gas state which adds positive buoyancy as the added gas displaces more air around the balloon and also eliminates the weight of being in a liquid state. In some sense, the system may be considered similar to a reusable elevator to go up and down by converting the multi-phase ballast gas between its gaseous and liquid state.

Reliance on non-reversible, finite supplies of lift gas and ballast to control altitude limit endurance and time on target of traditional small high-altitude balloons. For example, the traditional balloons rely on separate systems for venting lift gas to descend and/or dropping ballast to ascend. The resources used to control altitude are non-reversible for the traditional balloons—as soon as the traditional balloons vents gas or drops ballast, there is no recovering the resource to control the altitude. As a result, the traditional balloons cannot make frequent or continuous altitude adjustments, for example, to reach altitudes with wind layers that change over time risking exhaustion of lifting gas and/or expelling ballast entirely. Rather, as soon as the resource is used, the traditional balloons have no way of recovering the resource.

The high-altitude balloon may allow for repeatable altitude manipulation, which can be optimized for direction, range, or maintaining a static location over a week at a time. The high-altitude balloon provides a range of capabilities to create numerous potential mission sets. In some examples, the performance of the high-altitude balloon includes: a range of 1000s kilometers (km), float time of more than 1 week, repeatable altitude control of 15-30 km, cost of less than $10,000, with lift gas of hydrogen, helium, and/or ammonia. The high-altitude balloon includes the following system characteristics: repeatable altitude manipulation (utilizing operable ballasting phase change system) and integrated platform capabilities (releasing ISR, releasing payloads, housing communications network, GPS/GNSS-denied environment capable, and/or the like).

Accordingly, the aspects described herein provide benefits over the traditional balloons. First, the traditional balloons include control systems that can control descent by further venting to lower altitudes. In these traditional balloons, there may be no ability to ascend again. Second, for example at nighttime, the gas contracts and the balloon loses significant buoyancy. With the system described herein, the ammonia liquid can turn into a gas to maintain the same altitude overnight. Which provides increased control through multi-day missions and the changing temperature.

### Example High-Altitude Balloon

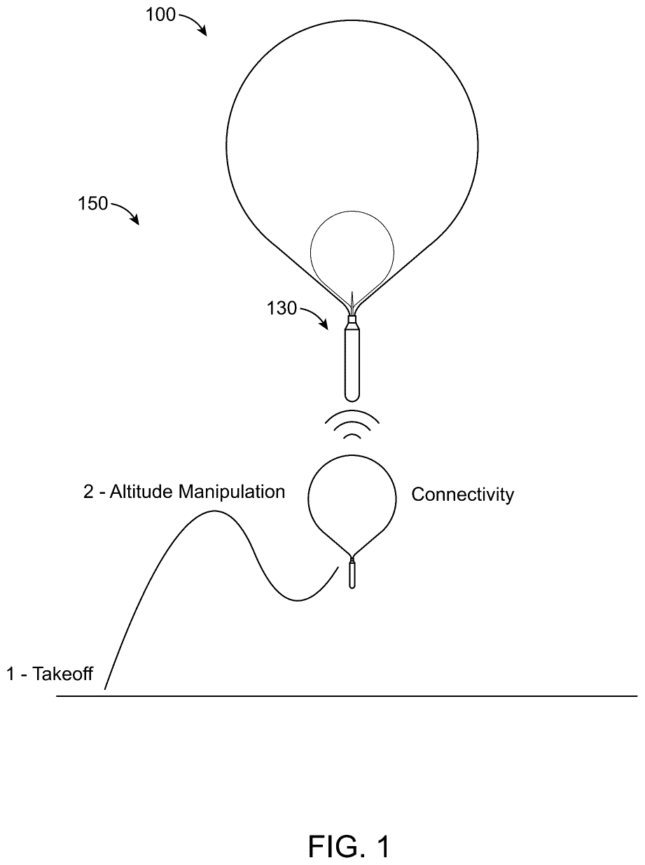

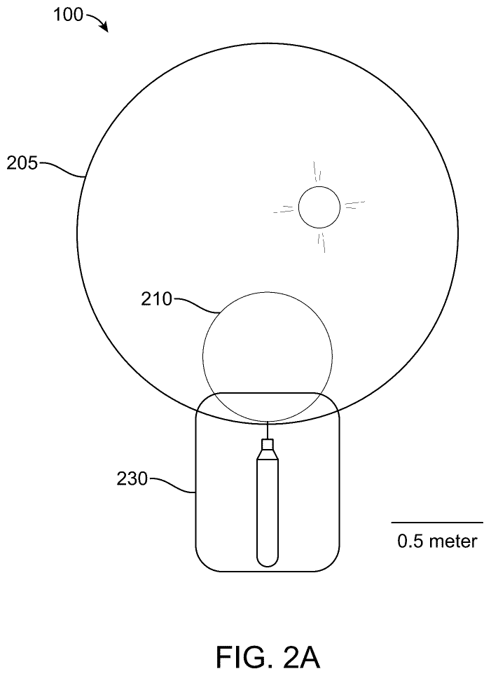

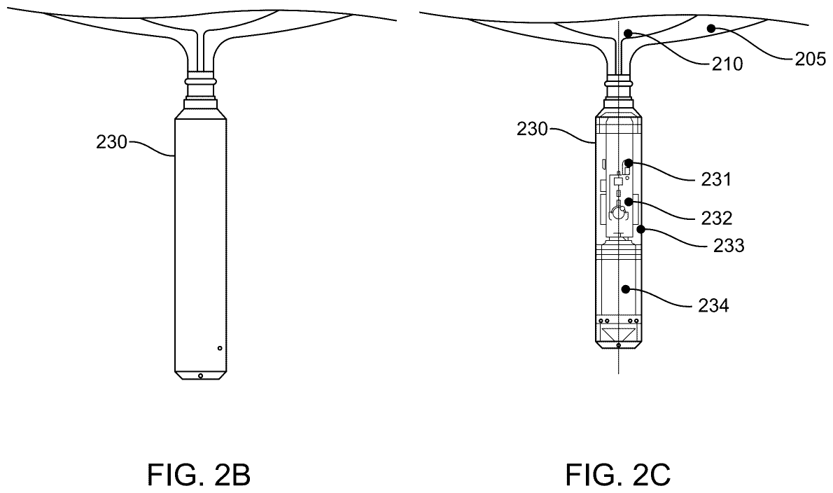

FIG. 1 illustrates a high-altitude balloon 100 that controls altitude changes of the high-altitude balloon 100 in response to environmental conditions of an external environment 150. The high-altitude balloon 100 may include aspects as described herein with respect to the balloon system 600 (for example, structural features and corresponding functions, such as main balloon 605, ballast ballonet 610, chassis 615, payload 630, and/or the like described in FIGS. 2A-13). In some cases, the high-altitude balloon 100 may include a ballast component 130 (such as ballast component 230 as described in FIGS. 2A-2C).

In some examples, the high-altitude balloon 100 may control a reversible phase change of a multi-phase ballast gas to respond to an environmental condition affecting the balloon. Controlling the reversible phase change may, e.g., adjust the altitude of the high-altitude balloon 100. In some cases, the environmental condition may include temperature (or volume (such as gas volume in the balloon and/or tank volume of the multi-phase ballast gas tank 234), altitude, pressure, mixture of gas in the high-altitude balloon 100 (such as a mixture between the lift gas and the multi-phase ballast gas), mixture of gas around the high-altitude balloon 100, light, altitude of the high-altitude balloon 100, and/or the like) affecting the high-altitude balloon 100. This external environment 150 may cause an initial pressure in the high-altitude balloon 100 to change to a modified pressure (for example, decrease in pressure due to a decrease in temperature surrounding the high-altitude balloon 100). In some cases, the change in pressure may cause the high-altitude balloon 100 to descend.

As described herein, the high-altitude balloon 100 may control altitude of the high-altitude balloon 100 in response to an environmental condition. For example, in response to the environmental condition causing descent of the high-altitude balloon 100, the high-altitude balloon 100 may control the phase change of the multi-phase ballast gas (for example, from liquid stored in a ballast tank to gas) to increase an amount of gas in the high-altitude balloon 100, causing the high-altitude balloon 100 to ascend (compensating for the descent). Using the approach of continuously controlling the phase of the multi-phase ballast gas, the high-altitude balloon 100 may continuously account for changes in the environmental condition by controlling the reversible phase change of the ballast gas.

The high-altitude balloon 100 may include a fill gas and the balloon has a total volume. The fill gas may include some combination of a lift gas and a multi-phase ballast gas. The lift gas has a lift gas volume and the multi-phase ballast gas has a multi-phase ballast gas volume. In combination, the lift gas volume and the multi-phase ballast gas volume are the fill gas volume. The fill gas volume may mostly include the lift gas volume (for example, in some cases, between about 50% and 90% and above) and the remaining portion of the fill gas volume may be the multi-phase ballast gas volume (for example, 10%-25%). In some cases, the proportion of the lift gas volume and the multi-phase ballast gas volume may change. The lift gas may be helium, hydrogen, and/or the like. The multi-phase ballast gas may be ammonia, hydrogen chloride, propylene, propane, nitrous oxide, dimethyl ether, R32, R410a, R143a, R1234ze(E), R125, and/or the like.

The fill gas, the lift gas, and the multi-phase ballast gas each have various characteristics (e.g., total pressure, composition, total volume, volume, and the like). In some cases, those characteristics can change (such as a change to total pressure, composition, total volume, and/or the like). For example, in some cases, the total pressure of the fill gas may change in response to the environmental condition. To illustrate, as the temperature declines from daytime to nighttime, the fill gas pressure may decrease as temperature decreases. Because of the decrease in pressure, the high-altitude balloon 100 may drop in altitude. In some cases, in response to detecting the temperature decline, the multi-phase ballast gas may change from a liquid phase to a gas phase to offset the change in pressure due to temperature decline. For example, the solenoid valve 231 may allow the multi-phase ballast gas to be released from the tank 234 into the ballast ballonet 210 to increase the fill gas pressure to maintain the altitude. Alternatively, the compressor may pump the multi-phase ballast gas from the ballast ballonet 210 into the tank 234.

The multi-phase ballast gas may be lighter than air (such as 59% of air density) and at high altitude (for example, greater than seven miles), the multi-phase ballast gas can be liquified with only moderate pressure (for example, 2 psi). In this way, the volume of gas in the high-altitude balloon 100 can be changed with the compressor 232. For example, the compressor 232 may compress the multi-phase ballast gas according to a compression time benchmark (such as about 30 minutes, which may match sunrise/sunset transitions) and compressor power (about 35 W for a reference case). The high-altitude balloon 100 as described herein can thereby move freely up and down the air column using electrical power.

In some cases, the high-altitude balloon 100 may include separate bladders. For example, a first bladder may include lift gas (such as helium, hydrogen, and/or the like) and a second bladder may include multi-phase ballast gas (such as ammonia). In some examples, the second bladder may be at least partially within the first bladder. The second bladder may allow for avoiding mixture of the lift gas with the multi-phase ballast gas. The separation of the gases may improve venting safety before landing. Conversely, in some cases, the high-altitude ballon may include a single bladder where gases from the fill gas mix freely.

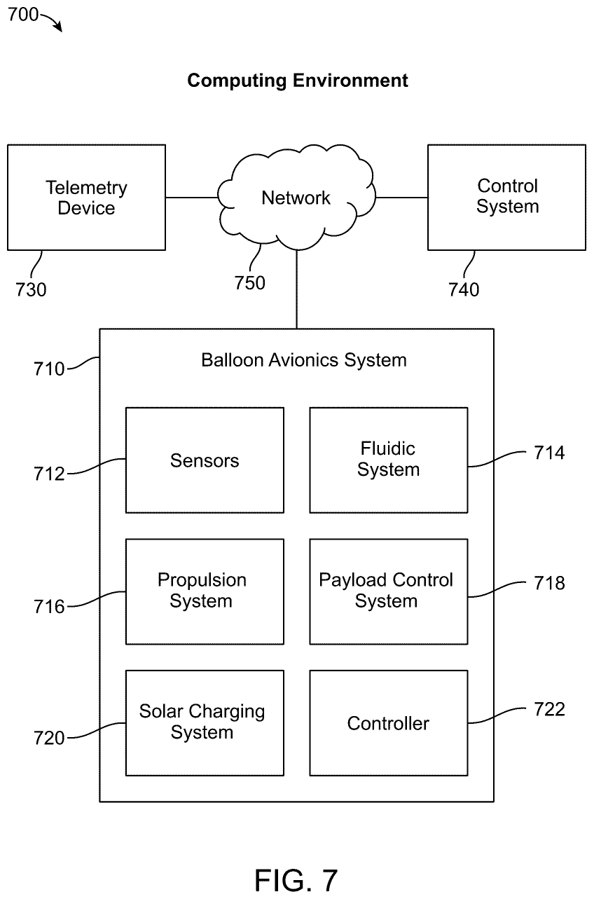

FIGS. 2A-2C illustrate a ballast component 230 of the high-altitude balloon 100 to allow control of altitude based on an external environment adjusting the altitude of the high-altitude balloon 100. In some examples, the ballast component 230 may include features and aspects as described herein with respect to the fluidic system 714 and/or sensors 712 (for example, the components as functions as described in FIG. 7). The ballast component 230 may include a solenoid valve 231, a compressor 232, a battery 233, a multi-phase ballast gas tank 234, a ballast ballonet 210, and a main balloon 205. Additionally, the elements depicted in FIGS. 2A-2C may have functionality different than what is described herein, or the functionality of one element may be attributable to a different element. Moreover, depending on the configuration, some of the functionality provided by depicted elements may be provided by elements different or external to the elements depicted in FIGS. 2A-2C.

The solenoid valve 231 may be an actuated flow control device positioned in a gas conduit between the ballast ballonet 210 and the multi-phase ballast gas tank 234. The solenoid valve 231 may include a valve body with an inlet port connected to the ballast ballonet 210, an outlet port leading toward the multi-phase ballast gas tank 234, and an internal sealing mechanism actuated by an electromagnetic solenoid coil. In some cases, in response to receiving an electrical signal from a controller (such as controller 722), the solenoid valve 231 may generate a magnetic field (for example, from a coil within the solenoid valve 231). The magnetic field may move an armature or plunger, opening or closing the solenoid valve 231 to permit or prevent the flow of multi-phase ballast gas.

The solenoid valve 231 controls venting of multi-phase ballast gas into the ballonet 210. The venting of multi-phase ballast gas into the ballonet 210 allows for buoyancy increase or isolation of the tank during compression and storage in the liquid phase. As the solenoid operates in variable environmental conditions, the solenoid valve 231 may include materials to withstand temperatures typical of stratospheric environment conditions (for example, −70° F.). Moreover, the solenoid may operate at variable pressures ranges. For example, the solenoid may operate about 2 psi and about 5 psi, but could be configured to operate at different ranges outside or withing those values depending on the configuration.

The compressor 232 may be a gas compression system coupled to the multi-phase ballast gas tank 234, for example, via a high-pressure conduit. The compressor 232 may be a piston or vane compressor, capable of compressing the multi-phase ballast gas. For example, the compressor 232 may compress the multi-phase ballast gas from low atmospheric pressure to a storage pressure. The low atmospheric pressure may be near zero absolute gauge. The storage pressure may be between about 2 psi and about 3 psi, but could be configured to operate at different ranges outside or withing those values depending on the configuration.

The compressor 232 may include an intake and a discharge. The intake may fluidically (and/or gaseously) connect to the ballonet 210. The discharge may couple to the multi-phase ballast gas tank 234. The compressor 232 may receive power from the battery 233 and may receive instructions from the controller 722. The controller 722 may control the compressor 232 to operate during altitude adjustment cycles (e.g., during descent initiation by converting ammonia gas to liquid). For example, the compressor 232 may compress the multi-phase ballast gas according to a compression time benchmark (such as about 30 minutes, which may match sunrise/sunset transitions) and compressor power (about 35 W for a reference case of a 10 lb. payload). The compressor 232 may include material and lubricant to accommodate heating caused by compression and cooling during multi-phase ballast gas expansion.

The battery 233 may include a battery housed in a thermally insulated section of the ballast component 230. The battery 233 may provide electrical power to the components of the ballast component 230, for example, the compressor 232 and solenoid valve. In some cases, the battery 233 may provide approximately 35 W to the compressor 232, but could provide different amounts of power depending on the configuration. The battery 233 may couple to the compressor 232 and the solenoid valve 231 via regulated power lines and control circuitry. In some cases, the battery 233 may include lithium-ion, lithium-polymer, and/or the like for high energy density and low-temperature tolerance.

The multi-phase ballast gas tank 234 may be a sealed, pressure-rated vessel positioned at the lower end of the ballast component 230. The ballast component 230 may provide a variable downward force proportional to the liquid multi-phase ballast gas stored in the multi-phase ballast gas tank 234. The multi-phase ballast gas tank 234 may receive multi-phase ballast gas in the liquid phase from the compressor 232 during compression (where the multi-phase ballast gas condenses into liquid form due to the combined effect of moderate pressure and ambient stratospheric cold). The multi-phase ballast gas tank 234 may include fittings for both the intake from the compressor 232 and an outlet toward the solenoid valve 231, allowing reversible movement of the multi-phase ballast gas between the multi-phase ballast gas tank 234 and the ballast ballonet 210. The multi-phase ballast gas tank 234 may include a volume sized to accommodate an operational quantity of multi-phase ballast gas (for example, comprising approximately 10-25% of the total gas volume). In some cases, the multi-phase ballast gas tank 234 may include materials compatible with the multi-phase ballast gas.

The ballast ballonet 210 may be a gas-containing chamber coupled to the ballast component 230. The ballast ballonet 210 may receive a multi-phase ballast gas, such as ammonia, in gaseous form to contribute to buoyancy of the high-altitude balloon 100, and to release the multi-phase ballast gas to compression and storage in liquid form within the ballast component 230 to reduce buoyancy. The ballast ballonet 210 may be internal or adjacent to the main balloon 205. The ballast ballonet 210 may include flexible materials resistant to the chemical properties of the multi-phase ballast gas and compatible with stratospheric temperatures. In some cases, the ballast ballonet 210 may be separate from the primary lifting gas volume to permit independent phase-change manipulation and venting of the multi-phase ballast gas without affecting or interacting with the lifting gas. The ballast ballonet 210 may receive (and provide) the multi-phase ballast gas to perform repeatable ascent and descent cycles over multi-day missions, thereby maintaining target altitude despite environmental variations such as diurnal temperature swings.

The main balloon 205 may include a gas-containing chamber including a lift gas volume. The lift gas volume may include the lift gas. The lift gas may be helium, hydrogen, and/or the like (for example, the lift gas may have a density approximately 7% that of ambient air). The lift gas may provide the primary buoyant force to lift the ballast component 230. The main balloon 205 may include dimensions to achieve a desired lift capacity based on weight of the ballast component 230 (and/or payload 630). In some cases, the lifting gas may blend with a multi-phase ballast gas to support altitude control functions, or maintained separately via dedicated internal chambers to enable isolated management of each gas component

### Example System Diagrams

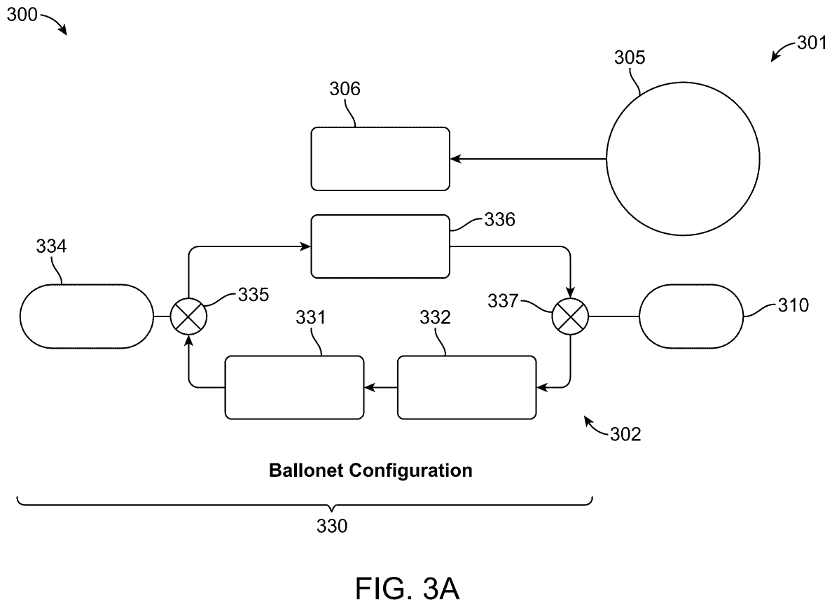

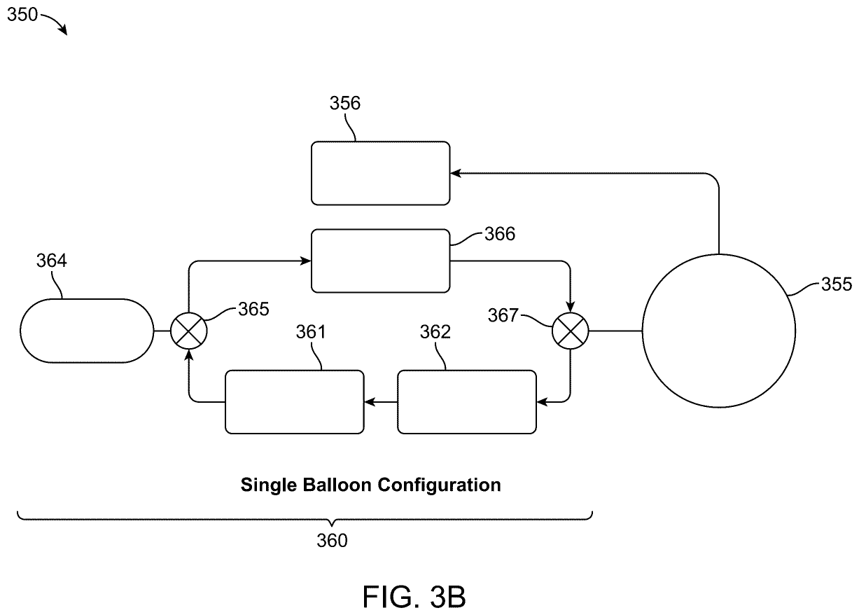

FIGS. 3A-3B illustrate example system diagrams for various configurations of a multi-phase altitude control system. In some cases, the high-altitude balloon 100 may include one or more of the configurations. FIG. 3A illustrates a first diagram of a system 300 for the multiphase altitude control system, according to an example aspect. The functions of the components may also be distributed, and/or performed, in a different manner than described below.

The multi-phase altitude control system may include separate balloons, a ballast ballonet 310 for a multi-phase ballast gas and a main balloon 305 for a lift gas. The main balloon 305 may include the ballast ballonet 310 (for example, as an internal bladder). The separation of the balloons may reduce pump requirements at the expense of balloon complexity.

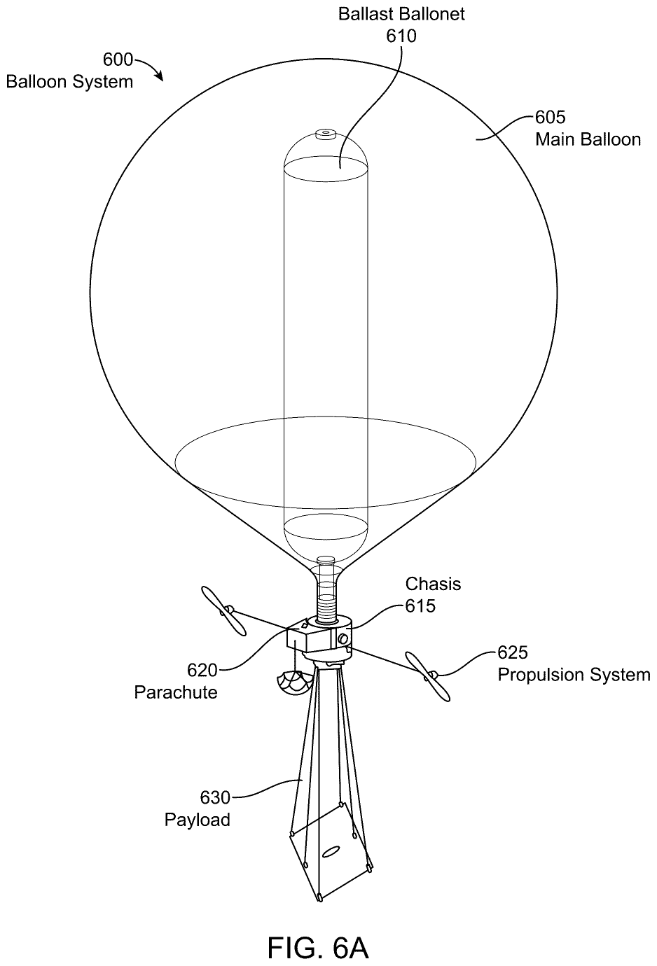

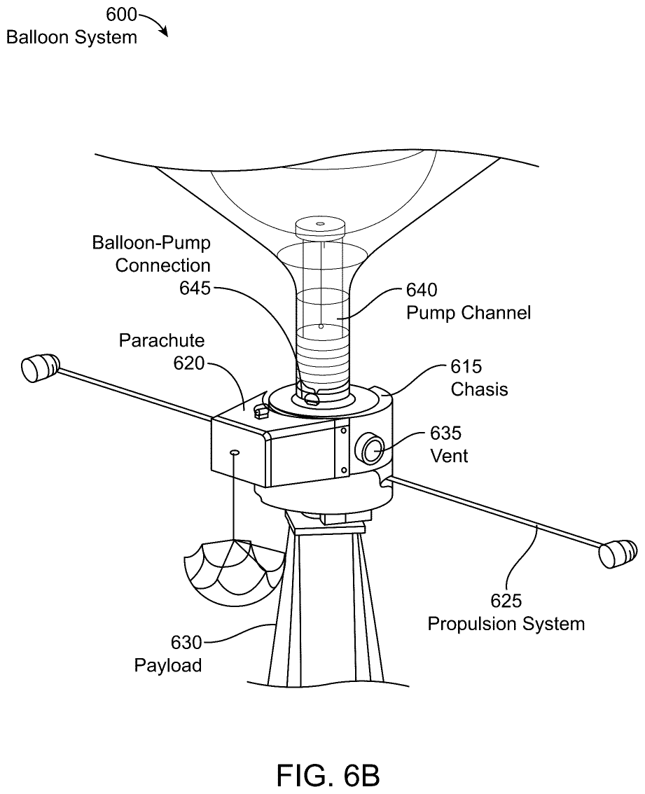

The system 300 may include a main balloon portion 301 and a ballast ballonet portion 302. The main balloon portion 301 may include a main balloon 305 and a vent valve 306. The main balloon 305 may be as described herein (for example, the main balloon 605 in FIGS. 6A-6B and the main balloon 205 in FIGS. 2A-2C). The vent valve 306 may vent air from the main balloon 305 to decrease lift gas volume. The valve 306 may be proportional or on/off types and can incorporate check elements to prevent backflow.

The ballast ballonet portion 302 may include a ballast ballonet 310, a ballast tank 334, and a ballast component 330. The ballast ballonet 310 may couple to the ballast component 330 and the ballast tank 334. For example, the ballast ballonet 310 may fluidically (and/or gaseously) couple to the ballast component 330. The ballast component 330 may provide for flow of multi-phase ballast gas between the ballast ballonet 310 and the ballast tank 334. Because of the flow between the ballast ballonet 310 and the ballast tank 334, the high-altitude balloon 100 may control a phase change of the multi-phase ballast gas to maintain an altitude despite changes to the altitude caused by an environmental condition. The ballast ballonet 310 may be as described herein (for example, the ballast ballonet 610 in FIGS. 6A-6B and the ballast ballonet 210 in FIGS. 2A-2C). In some cases, the ballast ballonet 310 may be within of the main balloon 305 (entirely or substantially within the main balloon 305). In other cases, the ballast ballonet 310 may be outside of the main balloon 305.

The ballast component 330 may control flow into and out of the ballast ballonet 310, according to one or more aspects. For example, the ballast component 330 may control a phase change of the multi-phase ballast gas to change a pressure in the main balloon portion 301 and/or the ballast ballonet portion 302 (for example, from a modified pressure to a compensated pressure). The ballast component 330 may include a compressor 332, a check valve 331, a first nozzle 335, a control valve 336, and a second nozzle 337.

In some cases, the ballast component 330 may include a sensor (not shown; such as sensor 712 in FIG. 7) to provide real-time measurements of environmental conditions, such as pressure (inside the main balloon 305 and/or the ballast ballonet 310, external to the main balloon 305 and/or the ballast ballonet 310, and/or the like). The sensor 712 may provide measurement for closed-loop regulation by an onboard controller (such as controller 722 in FIG. 7). The controller 722 may command valve states and compressor speed to achieve target altitude, trim, and envelope shape under changing thermal and wind conditions.

In operation, the controller 722 may decrease a total volume of gas of the high-altitude balloon 100 by opening the check valve 331 and driving the compressor 332 to decrease a multi-phase ballast gas volume and cause the phase change into a liquid phase for storage in the ballast tank 334. In some cases, the controller 722 may increase the total gas volume by actuating the control valve 336 to increase the multi-phase ballast gas volume and cause the phase change into a gas phase provided to the ballast ballonet 310. The controller 722 may control the multi-phase ballast gas to achieve a target volume. The target volume may be between about 10% and about 25% of the total volume of gas. The compressor 332 may be as described herein (for example, the compressor 232 in FIGS. 2A-2C).

The system 300 may include systems for controlling interchange between the ballast ballonet 310 and the ballast tank 334. For example, the system 300 may include a check valve, which 331 may be as described herein (for example, the solenoid valve 231 in FIGS. 2A-2C). The check valve 331 may selectively route inflow from the compressor 332 to the first nozzle 335 and into the ballast tank 334. The first nozzle 335 may allow flow of multi-phase ballast gas from the ballast ballonet 310 into the ballast tank 334. The control valve 336 may be as described herein (for example, the solenoid valve 231 in FIGS. 2A-2C). The control valve 336 may cause the phase change to expel the multi-phase ballast gas from the ballast tank 334 to the second nozzle 337 and into the ballast ballonet 310 to achieve the target altitude. The valves 331, 336 may be proportional or on/off types and can incorporate check elements to prevent backflow. The second nozzle 337 may allow flow of multi-phase ballast gas from the ballast tank 334 into the ballast ballonet 310. The ballast component 330 may include fluidic channels to couple the components of the ballast component 330. The fluidic channels may include filters and mufflers to manage particulates and acoustic emissions.

FIG. 3B illustrates a second diagram of a system 350 for multiphase altitude control system. For example, the multi-phase altitude control system may include a single balloon; a main balloon 355 for a total volume of gas, including a lift gas volume and a multi-phase ballast gas volume.

The second system 350 may include the main balloon 355, a vent valve 356, a ballast tank 364, and a ballast component 360. The main balloon 355 may be as described herein (for example, the main balloon 605 in FIGS. 6A-6B and the main balloon 205 in FIGS. 2A-2C). The functions of the components may also be distributed, and/or performed, in a different manner than described below.

The vent valve 356 may vent air from the main balloon 355 to decrease lift gas volume. The valve 356 may be proportional or on/off types and can incorporate check elements to prevent backflow. The main balloon 355 may couple to the ballast component 360 and the ballast tank 364. For example, the main balloon 355 may fluidically (and/or gaseously) couple to the ballast component 360 and the ballast component 360 may fluidically (and/or gaseously) couple to the ballast tank 364. The ballast component 360 may provide for flow of multi-phase ballast gas between the main balloon 355 and the ballast tank 364. Because of the flow between the main balloon 355 and the ballast tank 364, the high-altitude balloon 100 may control a phase change of the multi-phase ballast gas to maintain an altitude despite changes to the altitude caused by an environmental condition.

The ballast component 360 may control flow into and out of the main balloon 355, according to one or more aspects. For example, the ballast component 360 may control a phase change of the multi-phase ballast gas to change a pressure in the main balloon 355 (for example, from a modified pressure to a compensated pressure). The ballast component 360 may include a compressor 361, a check valve 362, a first nozzle 365, a control valve 366, and a second nozzle 367. In some cases, the ballast component 360 may include a sensor (not shown; such as sensor 712 in FIG. 7) to provide real-time measurements of environmental conditions, such as pressure (inside the main balloon 355, external to the main balloon 355, and/or the like).

The sensor 712 may provide measurement for closed-loop regulation by an onboard controller (such as controller 722 in FIG. 7). The controller 722 may command valve states and compressor speed to achieve target altitude, trim, and envelope shape under changing thermal and wind conditions. In operation, the controller 722 may decrease a total volume of gas of the high-altitude balloon 100 by opening the check valve 362 and driving the compressor 361 to decrease a multi-phase ballast gas volume and cause the phase change into a liquid phase for storage in the ballast tank 364. In some cases, the controller 722 may increase the total gas volume by actuating the control valve 366 to increase the multi-phase ballast gas volume and cause the phase change into a gas phase provided to the main balloon 355.

The compressor 361 may be as described herein (for example, the compressor 232 in FIGS. 2A-2C). The check valve 362 may be as described herein (for example, the solenoid valve 231 in FIGS. 2A-2C). The check valve 362 may selectively route inflow from the compressor 361 to the first nozzle 365 and into the ballast tank 364. The first nozzle 365 may allow flow of multi-phase ballast gas from the main balloon 355 into the ballast tank 364. The control valve 366 may be as described herein (for example, the solenoid valve 231 in FIGS. 2A-2C). The control valve 366 may cause the phase change to expel the multi-phase ballast gas from the ballast tank 364 to the second nozzle 367 and into the main balloon 355 to achieve the target altitude. The valves 362, 366 may be proportional or on/off types and can incorporate check elements to prevent backflow. The second nozzle 367 may allow flow of multi-phase ballast gas from the ballast tank 364 into the main balloon 355. The ballast component 360 may include fluidic channels to couple the components of the ballast component 360. The fluidic channels may include filters and mufflers to manage particulates and acoustic emissions.

The multi-phase ballast gas may blend with the lift gas in a single balloon or kept in a separate balloon (such as the ballast ballonet 310). The multi-phase ballast gas being kept in the ballast ballonet 310 may avoid compressing and venting the lift gas, and also allows the multi-phase ballast gas to be vented (for example, the high-altitude balloon 100 may vent the multi-phase ballast gas for safety before landing without venting the lift gas). In some examples, the multi-phase ballast gas may be one or more of the gases listed in Table 1. Table 1 also includes relative performance of each of the respective gases. Table 1 shows characteristics of the various gases for a reference mission with 2 lb. of multi-phase ballast gas. Any of these gases can be used according to the principles described herein.

TABLE 1

| | | | | Pump | | |
|---|---|---|---|---|---|---|
| Gas | | Relative | Tank | pre- | Pump | Lift |
| Candidate | Formula | Density | size | ssure | power | change |
| — | — | (% of | gal | psi | Watts | % |
| | | air) | | | | |
| Ammonia | NH₃ | 0.59 | 0.37 | 2.2 | 35 | 32.5 |
| Hydrogen | HCl | 1.26 | 0.24 | 56.9 | 432 | 15.2 |
| chloride | | | | | | |
| Propylene | C₃H₆ | 1.46 | 0.43 | 7.8 | 51 | 13.2 |
| Propane | C₃H₈ | 1.53 | 0.44 | 5.6 | 35 | 12.6 |
| Nitrous | N₂O | 1.52 | 0.23 | 70.5 | 443 | 12.6 |
| oxide | | | | | | |
| Dimethyl | CH₃OCH₃ | 1.6 | 0.34 | 1.1 | 7 | 12.0 |
| ether | | | | | | |
| R32 | CH₂F₂ | 1.81 | 0.22 | 9.6 | 51 | 10.6 |
| R410a | CH₂F₂/ | 2.52 | 0.19 | 9.4 | 36 | 7.6 |
| | C₂HF₅ | | | | | |
| R143a | C₂H₃F₃ | 2.92 | 0.22 | 7.5 | 24 | 6.6 |
| R1234ze(E) | C₃H₂F₄ | 3.97 | 0.19 | 0.2 | 1 | 4.8 |
| R125 | C₂HF₅ | 4.17 | 0.17 | 7.7 | 18 | 4.6 |

### Example Workflow Diagram

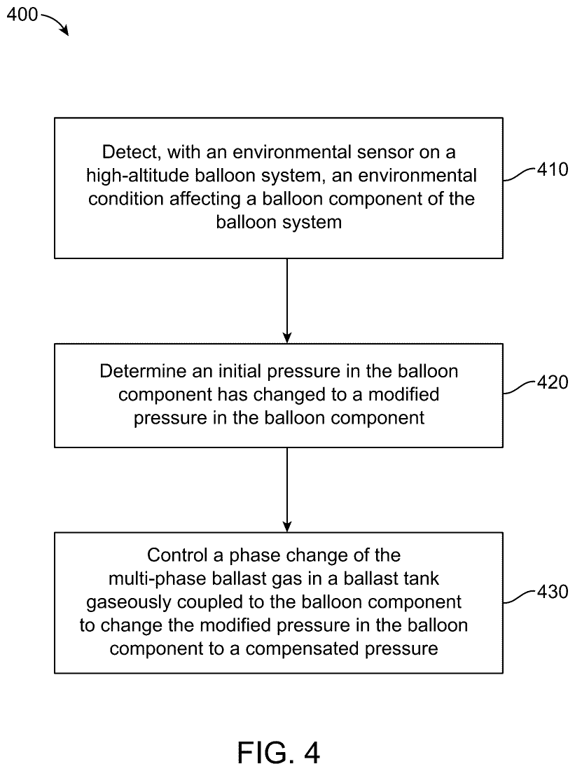

FIG. 4 illustrates an example workflow diagram of performing automatic environment response to control altitude based on an external environment adjusting an altitude of a high-altitude balloon 100, according to one example aspect. In the illustrated workflow 400, a balloon avionics system and its subsystems (e.g., sensors 712, fluidic system 714, propulsion system 716, payload control system 718, solar charging system 720, and/or controller 722) may perform additional or fewer actions, the actions may be performed in a different order, and/or one or more of the actions may be repeated or not performed.

In some aspects, the controller detects 410 an environmental condition affecting a balloon of the high-altitude balloon 100 to determine whether to perform a phase change of the multi-phase ballast gas to compensate for the environmental condition. In some cases, the balloon of the high-altitude balloon 100 may be the main balloon 605 and/or the ballast ballonet 610 (as described herein, for example, in FIGS. 6A-6B).

In some cases, in response to detecting the temperature decline, the multi-phase ballast gas may change from a liquid phase to a gas phase to increase the total volume (by increasing the multi-phase ballast gas volume) to offset the change in pressure due to temperature decline. For example, the solenoid valve 231 may allow the multi-phase ballast gas to be released from the tank 234 into the ballast ballonet 210 to increase the fill gas pressure to maintain the altitude. Alternatively, the compressor may pump the multi-phase ballast gas from the ballast ballonet 210 into the tank 234.

In some cases, the controller may detect the environmental condition by using sensors (for example, sensors 712 of FIG. 7). The environmental condition may be associated with an internal physical condition of the balloon, an external physical condition associated with the balloon, and/or the like. For example, as temperature around the high-altitude balloon 100 increases (for example, as the sun rises and applies thermal energy to the high-altitude balloon 100) the pressure of gas within the balloon increases. Conversely, as the temperature around the balloon decreases (for example, as the sun sets and reduces thermal energy to the high-altitude balloon 100), the pressure of gas decreases. To compensate for the change in the environmental condition, the controller may detect a temperature change and control the multi-phase ballast gas tank 234. In another case, the controller may detect an altitude change of the high-altitude balloon 100 and control the multi-phase ballast gas tank 234 to compensate for the altitude change (by, for example, by causing the phase change of the multi-phase ballast gas to increase the volume of gas in the balloon, causing the high-altitude balloon 100 to ascend). The sensors may generate a detection signal and send the detection signal to the controller indicating presence of the environmental condition.

In some aspects, the controller determines 420 an initial pressure in the balloon component has changed to a modified pressure in the balloon component. The initial pressure may be a pressure associated with the volume of gas in the balloon which allows the high-altitude balloon 100 to ascend to the altitude. In some cases, the modified pressure may be a pressure associated with the volume of gas in response to the environmental condition affecting the balloon. For example, the volume of gas in the balloon expanding in response to increased temperature around the high-altitude balloon 100. In some cases, the controller may determine the initial pressure changes to the modified pressure according to measurements by the sensors. The sensors may be a pressure sensor extending at least partially within the balloon to measure the initial pressure.

In some cases, the controller may compute an amount of phase change to implement based on the detected change in pressures. For example, the controller may compute the amount of the phase change based on volume of multi-phase ballast gas (such as the volume of multi-phase ballast gas in the ballast tank and/or the volume of multi-phase ballast gas in the volume of the balloon). In this way, there may be a relation between the amount of phase change to implement (such as an amount of the multi-phase ballast gas in the multi-phase ballast gas tank 234 to convert into gas, or conversely, an amount of gas to compress from the balloon).

In some cases, the controller may measure a current volume of the multi-phase ballast gas (corresponding to the initial pressure) in the ballast tank and a target volume of the multi-phase ballast gas (corresponding to the modified pressure) in the ballast tank. For example, the target volume may compensate for the change from the initial pressure to the modified pressure in the balloon. In some cases, the controller may cause the phase change of the multi-phase ballast gas according to the computed difference between the current volume of the multi-phase ballast gas and the target volume of the multi-phase ballast gas. For example, the controller may compute the difference between the target volume and the current volume and control the solenoid valve 231 to release gas from the multi-phase ballast gas tank 234 for a time duration (and/or until the sensors measure the volume of remaining multi-phase ballast gas in the multi-phase ballast gas tank 234 reaches the target volume). Conversely, the controller may compute the difference between the target volume and the current volume and control the compressor 232 to compress gas from the balloon for a time duration (and/or until the sensors measure the volume of remaining multi-phase ballast gas in the balloon reaches the target volume).

In some aspects, the controller controls 430 a phase change of the multi-phase ballast gas in a ballast tank fluidically (and/or gaseously) coupled to the balloon to change the modified pressure in the balloon to a compensated pressure to cause the high-altitude balloon 100 to compensate change in altitude according to the environmental condition. The adjustment of the altitude may correspond to a change in volume of the multi-phase ballast gas in response to the phase change. The control of the phase change may allow the high-altitude balloon 100 to control the altitude in response to the environmental condition. For example, in response to the environmental condition including a temperature decrease, the controller may expel the multi-phase ballast gas from the multi-phase ballast gas tank 234 into the balloon to maintain the altitude.

In some cases, the controller may implement a loop to determine (for example, continuously or substantially continuous) an adjustment to the multi-phase ballast gas to achieve the compensated pressure. The compensated pressure may correspond to the altitude of the high-altitude balloon 100. For example, the compensated pressure may maintain the altitude of the high-altitude balloon 100 in response to the initial pressure changing to the modified pressure. The adjustment to the multi-phase ballast gas may include the phase change of the multi-phase ballast gas from a first phase (such as a liquid) to a second phase (such as a gas).

In some cases, the controller may control the phase change by sending a signal to the compressor 232 to extract a portion of the multi-phase ballast gas from the balloon component, thereby causing the portion of the multi-phase ballast gas to undergo the phase change from a gas phase to the liquid phase. The phase change to the liquid phase may decrease the volume of the multi-phase ballast gas in the balloon (and increase the volume of the multi-phase ballast gas in the multi-phase ballast gas tank 234), which may provide a negative buoyancy effect on the altitude of the high-altitude balloon 100. The negative buoyancy effect may cause the high-altitude balloon 100 to descend. In this way, the controller may compute a buoyancy of the high-altitude balloon 100 from the pressure (such as the change from the initial pressure to the modified pressure and/or from the modified pressure to the compensated pressure). In this way, the controller may modify the buoyancy of the high-altitude balloon 100 to maintain the altitude.

In some cases, the controller may send a signal to a solenoid valve 231 to vent a portion of the multi-phase ballast gas volume from the multi-phase ballast gas tank 234 into the balloon. In this way, the venting may cause the portion of the multi-phase ballast gas to undergo a phase change from a liquid phase to a gas phase. The phase change to the gas phase may increase the volume of the multi-phase ballast gas in the balloon (and decrease the volume of the multi-phase ballast gas in the multi-phase ballast gas tank 234), which may provide a positive buoyancy effect on the altitude of the high-altitude balloon. The positive buoyancy effect may cause the high-altitude balloon 100 to ascend.

In some cases, the controller may engage a kill switch to the components of the high-altitude balloon 100 that may provide for descent in response to the kill switch (or destruction of the high-altitude balloon 100, or another action). The controller may engage the kill switch in response to the high-altitude balloon 100 reaching an airspace determined to be off-limits (such as restricted airspace). In some examples, the controller may generate a signal to the compressor 232 and/or solenoid valve 231 (or another component of the high-altitude balloon 100). The signal may instruct the component to cause the balloon to expel the multi-phase ballast gas to cause inflation of the balloon (or compression of the multi-phase ballast gas) according to the kill switch (for example, expel the multi-phase ballast gas to destroy the high-altitude balloon 100 or cause the high-altitude balloon 100 to land).

### Example Implementations

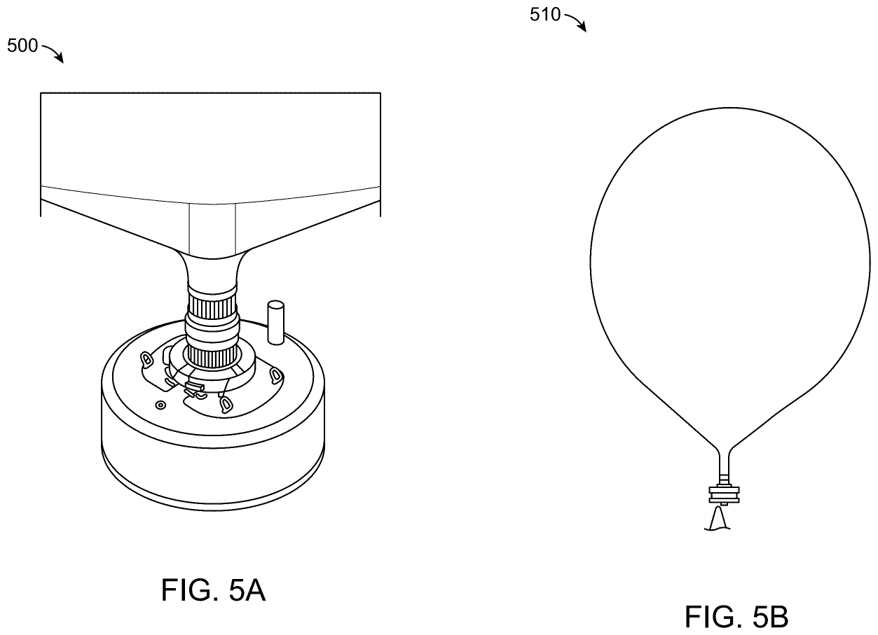

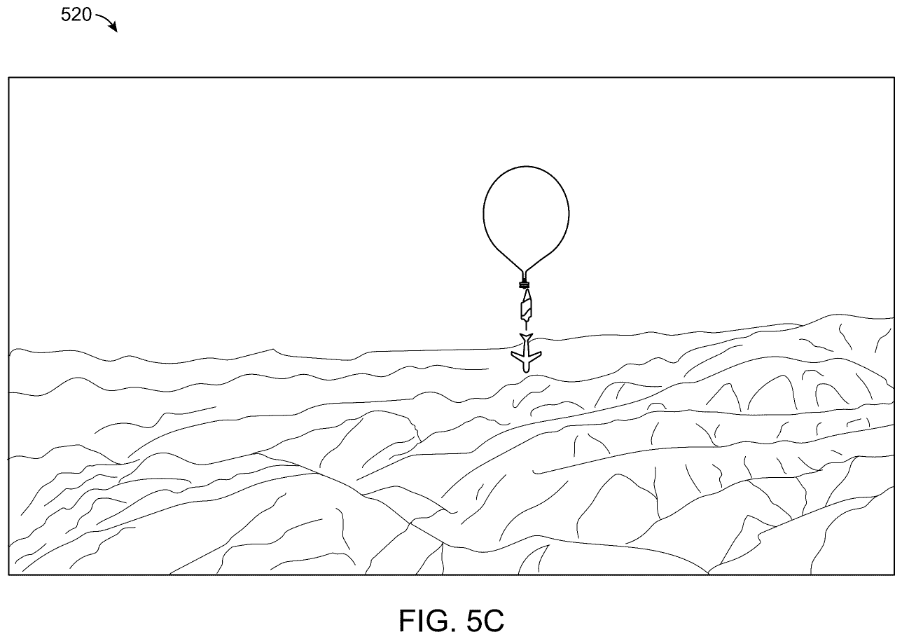

FIGS. 5A-5C are pictures of balloon systems 500, 510, 520, according to one or more aspects. As shown in the pictures, the balloon systems include the main balloon coupled to the multi-phase ballast gas flow system and/or the ballast tank. The balloon system further includes a payload (for example, a drone to deploy).

As illustrated in the pictures, the balloon system may be a high-altitude balloon system designed to enable precise and repeatable altitude manipulation for high-altitude balloons, utilizing a specialized mixture of multi-phase ballast gas and lift gas. By leveraging the phase change properties of the multi-phase ballast gas, the balloon system may eliminate reliance on traditional ballast system while enabling controlled ascent and descent. In removing the ballast system, the balloon system can carry payloads while providing navigation capability. The balloon system's reliance on the phase change of the multi-phase ballast gas provides a sustainable and efficient method for altitude regulation, allowing full exploitation of available winds, and ensuring reliable performance in dynamic atmospheric conditions.

Also shown in the pictures is an avionics system of the high-altitude balloon (such as avionics system 710 in FIG. 7). The avionics system can navigate autonomously and has a triplex flight termination system.

The balloon system prioritizes days aloft, maximum altitude, static capability, and complete navigation to optimize the balloon system for highest efficacy. In some cases, the balloon system may include an altitude operation limitation, which may allow for safe use in areas where (for instance) civilian aircraft may be present. In some examples, software executed by the balloon system may identify time spent at specific altitudes, and may limit the amount of multi-phase ballast gas manipulation at a certain time. Eventually, given the lack of multi-phase ballast gas in the closed loop system, nighttime cooling of the remaining gases may cause the balloon system to lower. In the event lowering catches the balloon system in an adverse wind pattern, directing flight over restricted air space, the balloon system may reengage lift gas in the system or activate a kill switch, lowering the balloon system to ground level immediately.

### Balloon System Overview

FIG. 6A illustrates a perspective view of the balloon system 600, according to one or more aspects. FIG. 6B illustrates a close-up perspective view of a chassis of the balloon system 600, according to one or more aspects.

In one or more aspects, the balloon system 600 includes two buoyant envelopes, namely a main balloon 605 and a ballast ballonet 610, and further comprises a chassis 615, a parachute 620, a propulsion system 625, and a payload 630. The components are operatively coupled. The main balloon 605 provides primary lift, while the ballast ballonet 610 affords adjustable buoyancy. The chassis 615 carries control and support hardware. The parachute 620 is deployable for safe descent or recovery. The propulsion system 625 provides maneuverable capability. The payload 630 delivers mission-specific functionality. Mechanical load paths and electrical and data connections are arranged to maintain stability and controllability across ascent, cruise, and descent phases.

The main balloon 605 functions as the principal lifting envelope. In various aspects, the main balloon 605 is composed of a flexible film or laminated composite. In other aspects, the main balloon 605 is constructed from a thermoplastic elastomer, or latex. In one or more aspects, the main balloon 605 is of tubular shape, i.e., having a uniform circular cross-section along a length of the balloon. In one or more aspects, the main balloon 605 is constructed by seaming flat sheets of material together. In one or more embodiments, the main balloon 605 is constructed by extruding layflat tubing of the balloon material.

The main balloon 605 may be constructed of material that is resistant to environmental conditions during operation of the balloon system 600. For example, the main balloon 605 is constructed of material that is resistant to ultraviolet exposure, low-temperature brittleness, or some combination thereof.

Prior to deployment of the balloon system, the main balloon 605 is filled with a lighter-than-air gas, e.g., helium or hydrogen, via a fill port that includes a check valve. The system may further include a relief valve or burst disc to protect against overpressure conditions. A reinforced neck or collar interfaces to the chassis 615 via one or more load lines or a harness, and may incorporate sensor ports for monitoring internal pressure, temperature, gas purity, or some combination thereof. Internal baffles or tie points can be used to limit gas slosh and maintain geometric stability under dynamic loads.

The ballast ballonet 610 provides a variable-volume ballast within the main balloon 605 to modulate net buoyancy and trim. In some aspects, the ballast ballonet 610 is an inflatable envelope of smaller volume than the main balloon 605. The ballast ballonet 610 may also be constructed from a gas-impermeable material. The ballast ballonet 610 is also filled with a gas using a pump mounted on the chassis 615. By increasing or decreasing the volume of the ballast ballonet 610, the ballast ballonet 610 can control altitude without venting lift gas. This empowers the ballast ballonet 610 to maintain envelope shape at varying external pressures, or counteract temperature-induced buoyancy changes. Valving may include an inlet valve, an outlet valve, and a pressure regulator to provide for controlled inflation and deflation.

The chassis 615 is a structural support for packaging of components or subsystems. The chassis 615 is mechanically coupled to the envelopes and to the payload 630. The chassis 615 may be formed from a metal, a metal alloy, a composite, a thermoplastic, or some combination thereof. The chassis 615 may include mounting interfaces for avionics, power storage, communications equipment, navigation sensors, other sensors, other components of the balloon system 600, or some combination thereof. The chassis 615 may further include electrical and data communication links between the propulsion system 625, the parachute 620, and the payload 630.

In one or more aspects, the chassis 615 includes a vent 635, a pump channel 640, and a balloon-pump connection 645. The vent 635 vents gas from the balloons out to the environment. Outflow of fluid through the vent 635 can be controlled with one or more valves and switches. The pump channel 640 is a fluidic channel for inflow or outflow of fluid to the main balloon 605 and/or the ballast ballonet 610. The balloon-pump connection 645 tethers the main balloon 605 and the ballast ballonet 610 to the chassis 615. In one or more aspects, balloon-pump connection 645 includes a release mechanism for detaching the main balloon 605 and/or the ballast ballonet 610 from the chassis 615.

The parachute 620 is configured for controlled descent and recovery of the balloon system 600. The parachute 620 includes one or more fabrics tethered to the chassis 615 with one or more strings. In certain aspects, the parachute 620 is folded and stowed in a box coupled to the chassis 615, with a deployment mechanism actuated by an onboard controller. In one or more aspects, the deployment mechanism is passive with a lid keeping the box closed. To deploy the parachute, the lid is detached from the box to deploy the parachute 620. The canopy area and line lengths are selected to achieve a predetermined terminal descent rate for the combined mass of the chassis 615, the payload 630, or some combination thereof. The parachute 620 may operate as an emergency system upon detection of envelope rupture or excessive venting. In other aspects, the parachute 620 may be deployed to increase drag, e.g., for stabilization during high-wind contexts.

The propulsion system 625 provides for lateral maneuvering, e.g., for station-keeping, heading control, and trajectory adjustments. Motors integrated with on-board controller modulate thrust to control navigation of the balloon system 600. For example, the controller can control motor operation to navigate the balloon based on GPS position, inertial measurements, wind estimation, target destination, etc., empowering the balloon system 600 to loiter over a target area or to navigate to a waypoint. Power may be supplied by rechargeable batteries, fuel cells, or solar-augmented systems.

In one aspect, the propulsion system 625 comprises multiple electrically driven propellers arranged around the chassis 615 with controllable thrust vectors to produce yaw, pitch, and roll moments as well as translational forces. The propellers may be coupled to motors positioned on ends of a linear propulsion rig extending laterally from the chassis 615.

In other aspects, the propulsion system 625 uses other types of thrusters. For example, the propulsion system 625 may implement a rocket engine that vents gas exhaust from combustion of propellant. In another example, the propulsion system 625 may implement a cold-gas thruster that releases pressurized inert gas. Upon depressurization, the gas expands, creating an exhaust that can be used to create thrust.

The payload 630 is suspended below the chassis 615 and may include, without limitation, solar charging equipment, imaging sensors, communication relays, environmental sampling instruments, delivery containers, or other mission-specific devices. The payload 630 can be enclosed in a thermally managed housing with vibration isolation mounts to preserve measurement integrity and may interface to the chassis 615 via quick-release hardware for rapid reconfiguration. Electrical connectors provide data and power, and the mass and center-of-gravity of the payload 630 are selected in concert with the ballast ballonet 610 volume range to maintain stability across operational regimes. In some aspects, the payload 630 may include a recovery beacon, tracking device to facilitate retrieval after parachute-assisted landing, ballast component, and/or the like.

### Computing Environment

FIG. 7 is a networking environment of a balloon system, according to one or more aspects. The computing environment 700 includes the balloon avionics system 710, the telemetry device 730, and the control system 740 in communication over the network 750. In other aspects, the computing environment 700 may include additional, fewer, or different components than those listed.

The balloon avionics system 710 is implemented on the balloon system (e.g., the balloon system 600) and integrates multiple functional subsystems for controlling operation of the balloon system. The balloon avionics system 710 includes sensors 712, a fluidic system 714, a propulsion system 716, a payload control system 718, a solar charging system 720, and a controller 722. The subsystems may share common electrical power from rechargeable batteries and/or fuel cells and communicate via wired or wireless intra-vehicle links (e.g., CAN, RS-485, I2C, or Ethernet) routed through a power distribution unit and a local data link. The avionics hardware may further include, for example, non-volatile memory for logging, GNSS timing, electromagnetic shielding, environmental sealing, redundant interfaces to permit fault-tolerant operation and safe fallback modes, or some combination thereof.

The sensors 712 capture sensor data characterizing operation of the balloon system. In various aspects, the sensors 712 may include an environmental sensor, which may include one or more of: GNSS receivers for position and velocity; an inertial measurement unit with gyroscopes, accelerometers, and magnetometers; barometric altimeters; ambient temperature, pressure, and humidity sensors; anemometers or pitot-static assemblies for wind speed and direction estimation; solar irradiance and sun-angle photodiodes for panel pointing; internal envelope and ballonet pressure or temperature sensors; gas-composition or leak-detection sensors; current, voltage, and state-of-charge monitors for the power system; strain gauges on tethers; vibration and acoustic sensors; optical cameras or low-light imagers; radar or lidar altimeters; and specialized atmospheric sensors such as ozone, particulate, or CO2 detectors. The sensors 712 can include onboard calibration references, perform built-in self-tests at startup, and supply fused estimates to the controller 722 at defined update rates.

The fluidic system 714 is provided to regulate inflow and outflow of gases to and from the balloons of the balloon system, including a main balloon and a ballast ballonet, thereby enabling closed-loop control of net buoyancy and trim. The fluidic system 714 may comprise a manifold with computer-controlled valves and switches, including solenoid on/off valves for discrete routing, proportional valves for metered flow, check valves to prevent backflow, and pressure-relief valves or burst discs for overpressure protection. Pumps, e.g., diaphragm pumps, positive-displacement blowers, or centrifugal fans, may be coupled to dedicated lines to ingest ambient air into the ballast ballonet, evacuate air from the ballonet, or purge lift gas from the main balloon through filtered orifices and converging nozzles. Flow switches and mass-flow sensors, together with pressure and temperature transducers located at the manifold and at each envelope, provide feedback to the controller 722 for precise actuation timing and rate control. The system can include electrically actuated isolation valves to prevent cross-contamination of lift gas and ballast air, quick-disconnect service ports, and redundant parallel flow paths for fault tolerance; all wetted materials may be selected for compatibility with the chosen lift gas (e.g., helium or hydrogen) and with environmental conditions expected during ascent, cruise, and descent.

The propulsion system 716 includes electronically controlled actuators and power electronics that generate and vector thrust for navigation of the balloon system. In one aspect, the propulsion system 716 includes electrically driven propellers coupled to motors for driving the propellers to create thrust. Thrust vectoring can be achieved with computer-controlled gimbals, servo motors, or differential throttling. Position feedback may be provided by encoders or potentiometers. Integrated sensors such as motor tachometers, winding temperature sensors, and current shunts provide for closed-loop control. Control signals from the controller 722 may be issued as PWM, CAN frames, or serial packets and executed via embedded PID or model-based control loops to achieve commanded force and moment setpoints.

The payload control system 718 controls release of an attached payload. The payload may be coupled to the chassis of the balloon system through one or more attachments. A detachment mechanism detaches the payload from the chassis. For example, the detachment mechanism may include electromechanical latches, pin-pullers, burn-wire cutters, or motorized hooks equipped with limit switches and load cells to verify secure stowage and positive release. The payload control system 718 can execute timed or location-based releases, perform staged drops from multiple ports, and report status and residual inventory to the controller 722 and to offboard operators. Post-release descent devices, such as small chutes or streamers attached to payloads, can be commanded and verified through the same interface.

The solar charging system 720 harvests energy from sunlight to recharge onboard storage and power the avionics. The system may include one or more photovoltaic panels mounted on adjustable brackets, a charge controller, and temperature-compensated battery management electronics. The sensors 712 may include one or more light sensors for gauging a direction of the sun relative to the photovoltaic panels. Based on the orientation, the solar charging system 720 can orient one or more panels toward the sun. The system can schedule panel pointing based on ephemeris predictions, detect shading or soiling, and throttle charging to manage thermal limits while maintaining sufficient aerodynamic stability.

In one or more aspects, the one or more photovoltaic panels are positioned as part of the payload of the balloon system. The one or more panels are coupled to a rotating hanger that can change a 360-degree orientation of the one or more panels. To change the orientation, the solar charging system 720 detects a position of the sun relative to the chassis of the balloon system. The solar charging system 720 can determine the desired orientation and actuate a motor to rotate the rotating hanger such that the photovoltaic panels are oriented as desired.

The controller 722 includes one or more processors and memories configured to receive data from the sensors 712, analyze the data, determine operating objectives, and generate command sequences for execution by the sensors, the fluidic system 714, the propulsion system 716, the payload control system 718, and the solar charging system 720. The controller 722 may host a real-time operating system implementing state machines for ascent, cruise, station-keeping, and recovery; perform estimation via sensor fusion and filtering; and evaluate health metrics against thresholds. Decision logic may include rule-based routines, optimization algorithms, or machine-learning models, and may account for power budgets, mission constraints, and environmental forecasts. The controller 722 logs telemetry, timestamps events, and supports redundant pathways for command and control.

For navigation, the controller 722 computes and follows trajectories using GNSS position, inertial attitude, and wind estimates derived from the sensors 712 and from external data. Lateral motion can be effected by generating control signals to cause the propulsion system 716 to generate thrust vectors in the lateral direction, or station-keeping or that exploit favorable wind layers for efficient transport. Altitude selection can be accomplished by coordinating with balloon-specific actuators (e.g., ballonet or vent controls, if present) and by predicting wind fields with altitude to choose energy-optimal strata. The controller 722 enforces geofences, no-fly zones, and safe-return waypoints, blends feedforward wind compensation with feedback tracking, and transitions between modes such as hold, waypoint, drift, and emergency recovery based on mission state and health status.

The telemetry device 730 is an external device that acquires environmental and operational data independent of the balloon avionics system 710 and makes such data available for flight management. The telemetry device 730 may be a satellite service, a weather radar, a ground station with meteorological instruments, an airborne relay, or another sensor platform that measures or infers winds, precipitation, turbulence, lightning risk, airspace activity, and communication link quality. Data from the telemetry device 730 can be ingested by the control system 740 and/or directly by the controller 722 to update forecasts, refine wind models, detect hazards, and revise navigation or energy-management plans. The telemetry device 730 may stream both real-time observations and predictive products for use in replanning trajectories or adjusting runtime operation.

The control system 740 operates as a supervisory system that monitors the health and performance of the balloon system and coordinates mission execution. The control system 740 can run on a ground computer or cloud server, receive telemetry from the balloon avionics system 710 and the telemetry device 730, and present status to operators. Operator inputs, such as mission start, hold positions, geofence definitions, payload scheduling, and recovery commands, are relayed by the control system 740 to the balloon avionics system 710 with appropriate authentication and priority handling. The control system 740 can upload mission parameters including waypoints, altitude bands, energy budgets, communications schedules, and contingency rules, and can enforce command authority hierarchies and manual override procedures.

The network 750 provides the data communications fabric between the balloon avionics system 710, the telemetry device 730, and the control system 740. Each component may include a transceiver and associated antennas to transmit and receive messages over one or more links, with support for redundancy and handover between available bearers. Example protocols and bearers include TCP/IP over LTE/5G, NB-IoT, or Wi-Fi; UDP with forward-error-correction over UHF/VHF or ISM radios; satellite links such as Iridium SBD, Inmarsat, or Globalstar; low-power wide-area links such as LoRa/LoRaWAN; and application-layer protocols such as MQTT, AMQP, CoAP, or DDS. Onboard subsystems may also communicate via CAN, RS-485, I2C, and Ethernet. The network 750 can employ encryption (e.g., TLS), authentication tokens, time synchronization (e.g., NTP or GPS-disciplined), and store-and-forward buffering to maintain reliable command, control, and data exchange throughout the mission.

### Balloon System Navigation

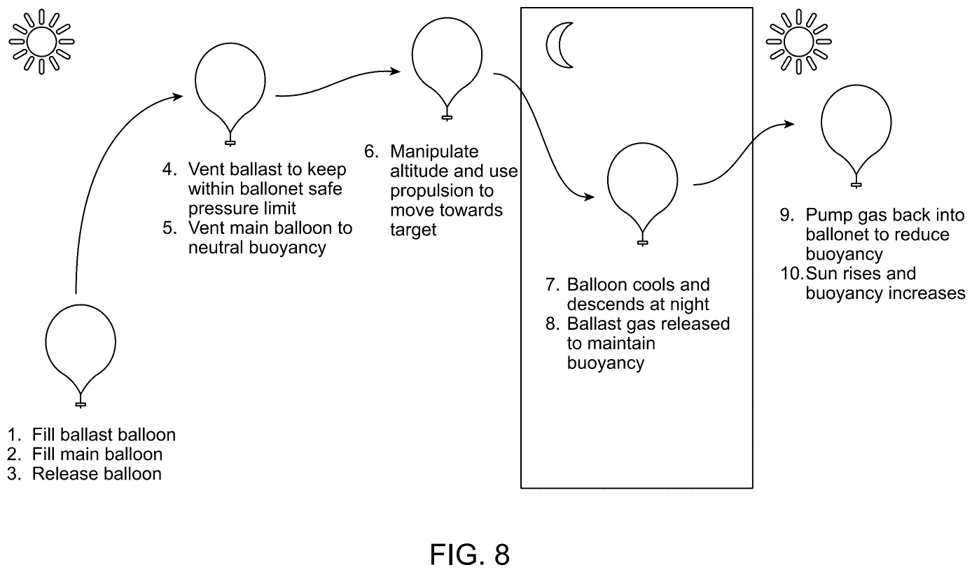

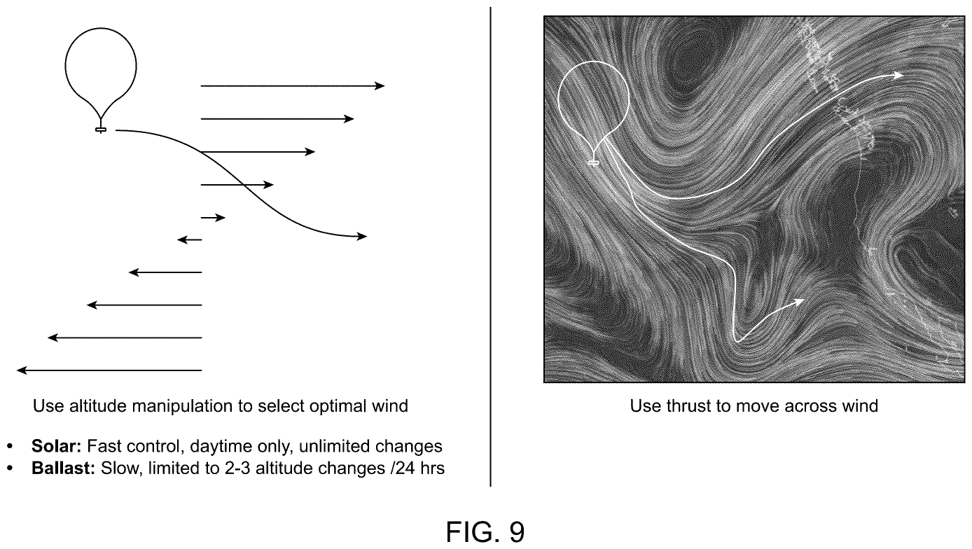

FIG. 8 is an illustrative diagram of controlling the flight of a balloon system, according to one or more aspects.

At initial deployment of the balloon system, the ballast ballonet and the main balloon is filled with gas. At the requisite fill level, the balloon system is released from one or more tethers to the ground.

As the balloon system ascends into the atmosphere, the balloon system can vent gas from the ballast ballonet to keep the ballast ballonet in a safe pressure limit. For example, a pressure sensor implemented inside or coupled to the ballast ballonet can capture internal pressure of the ballast ballonet. As the internal pressure changes, towards a limit of the safe pressure limit, the balloon system can vent gas from the ballast ballonet. The balloon system can also vent gas from the main balloon to maintain neutral buoyancy, e.g., between the main balloon and the ballast ballonet.

As the balloon system is mid-flight, the balloon system can manipulate altitude, use propulsion, or some combination thereof to control navigation of the balloon system. Controlling navigation of the balloon system may entail station-keeping (e.g., maintaining a global coordinate position and altitude), altitude adjustment, heading control, etc.

During the flight, if the daytime transitions to nighttime, the main balloon cools and descends with the cooled gas. The balloon system can continue to vent gas from the main balloon, the ballast ballonet, or some combination thereof to maintain buoyancy of the balloon system. Venting may entail transferring gas from the main balloon to the ballast ballonet, vice versa, venting gas from the main balloon or the ballast ballonet to the environment, or some combination thereof.

If nighttime transitions to daytime, the balloon system can pump gas back into the ballast ballonet to reduce buoyancy as the sun heats the gas in the main balloon.

FIG. 9 is an illustrative diagram of controlling the trajectory of the balloon system by altitude manipulation, according to one or more aspects. Wind patterns change with the altitude in the atmosphere. With known wind patterns, the balloon system can control its heading by adjusting altitude to move the balloon into an optimal wind vector, thereby carrying the balloon system along that vector.

In one or more aspects, the balloon system implements a dual-surface ballast ballonet with a light reflective side and a light absorptive side. With the dual-surface ballast ballonet, the balloon system can selectively orient the ballast ballonet to either reflect light, minimizing gas temperature change from incident light, or absorb light, increasing gas temperature from incident light.

The balloon system can further change altitude through venting gas to/from the ballast ballonet, thereby changing buoyance of the balloon system. As the venting process is gradual, the balloon system may be limited to a certain number of altitude changes in a time period, e.g., 2 or 3 altitude adjustments in a 24-hour span.

The balloon system may further leverage its propulsion system to thrust across wind.

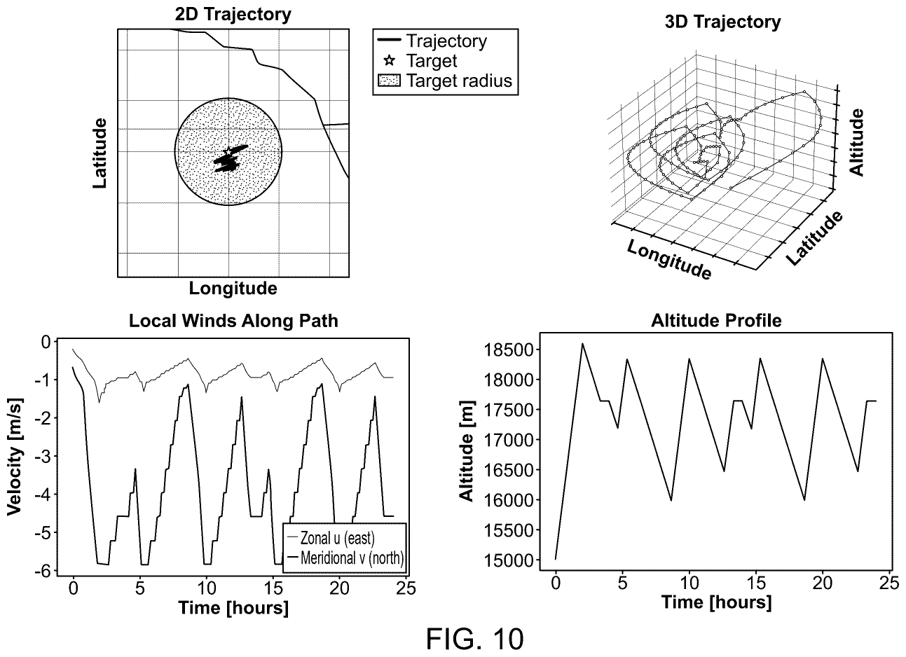

FIG. 10 shows plots in one example flight of a navigable balloon system, according to one or more aspects. The top left plot shows a two-dimensional trajectory (e.g., latitude and longitude) of the balloon system measured during the flight of the balloon system. The top right plot shows a three-dimensional trajectory (e.g., latitude, longitude, and altitude). The bottom left plot shows the local wind vector flow over time. The bottom right plot shows the altitude profile over time.

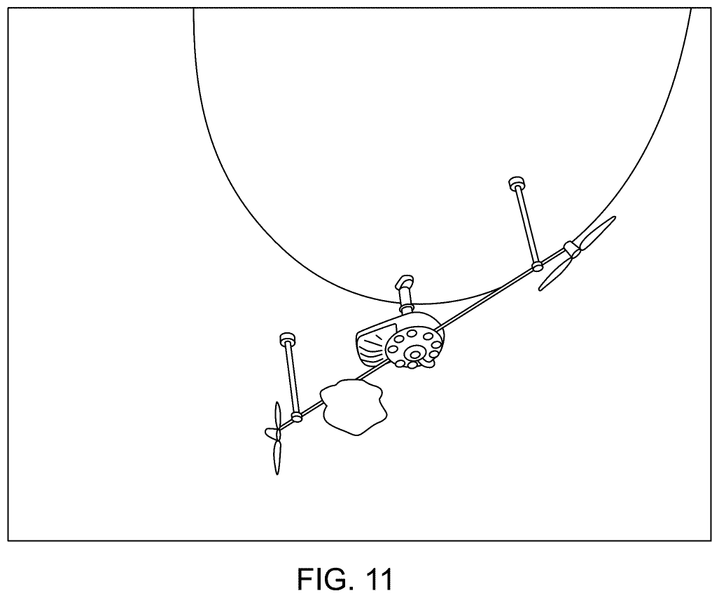

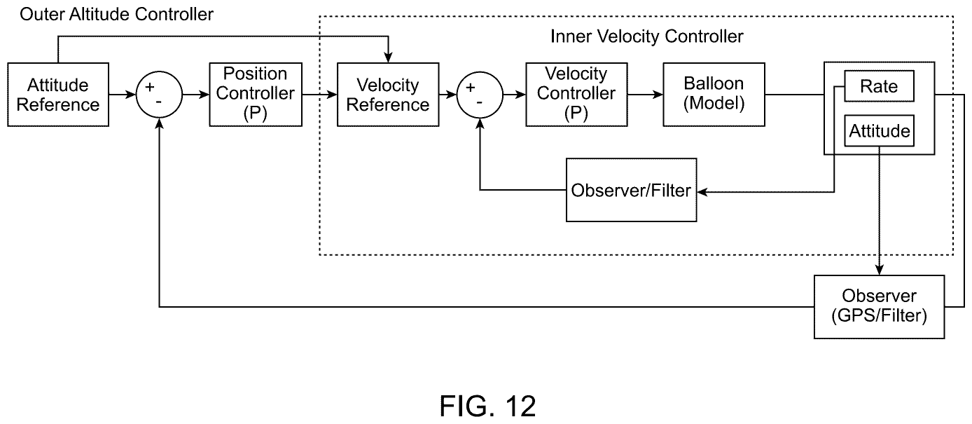

FIG. 11 is a picture of a balloon system, according to one or more aspects. As shown in the picture, the balloon system includes the main balloon coupled to the chassis. The balloon system further includes the propulsion system with motor-driven propellers coupled to either end of a linear rig extending from the chassis.

FIG. 12 is a system architecture implemented by the balloon system for balloon navigation, according to one or more aspects. In particular, a cascaded control architecture includes an outer altitude controller for generating a velocity reference for an inner velocity controller to regulate balloon motion. An altitude reference is compared to a measured state from an observer (GPS/filter) (e.g., from the balloon system or a telemetry device), and the resulting error is processed by a proportional position controller to produce a velocity reference. Within the inner velocity controller, this velocity reference is differenced with the estimated velocity from an observer, and a proportional velocity controller converts the velocity error into actuator commands for the balloon system (model), such as thrust vectoring or fluidic adjustments. Rate and attitude signals derived from onboard sensors are fused by the observer/filter and fed back to both the inner and outer loops, providing state estimates for error computation and gain scheduling. This cascaded control architecture can be implemented by the controller 722.

### Example Computing Diagram

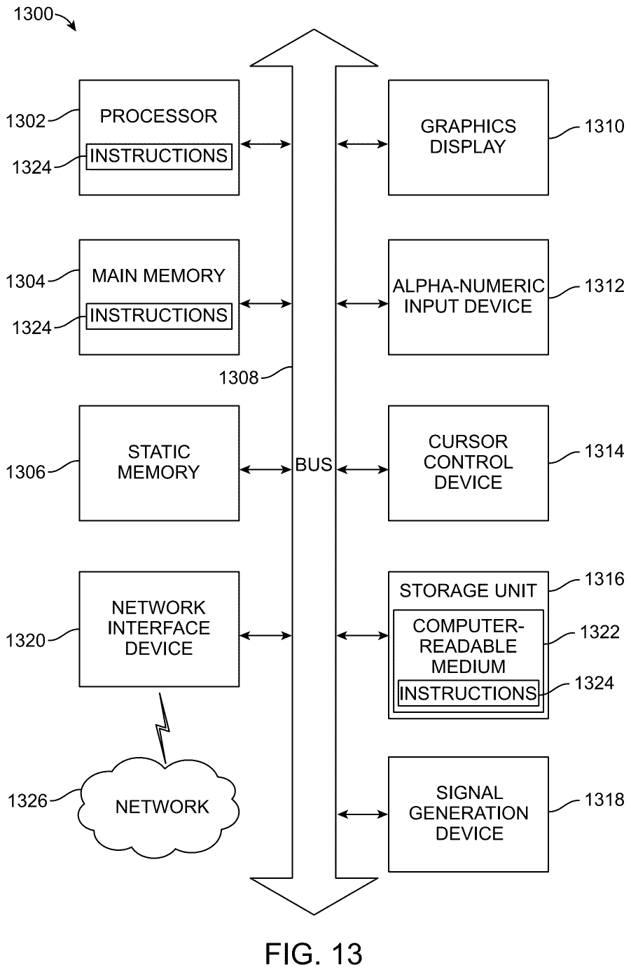

FIG. 13 is a block diagram illustrating components of an example computing machine that is capable of reading instructions from a computer-readable medium and execute them in a processor (or controller). A computer described herein may include a single computing machine shown in FIG. 13, a virtual machine, a distributed computing system that includes multiples nodes of computing machines shown in FIG. 13, or any other suitable arrangement of computing devices.

By way of example, FIG. 13 shows a diagrammatic representation of a computing machine in the example form of a computer system 1300 within which instructions 1324 (e.g., software, program code, or machine code), which may be stored in a computer-readable medium for causing the machine to perform any one or more of the processes discussed herein may be executed. In some aspects, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 13 may correspond to any software, hardware, or combined components shown in FIGS. 6A-6B and 7, including but not limited to, the balloon avionics system 710, telemetry device 730, control system 740. While FIG. 13 shows various hardware and software elements, each of the components described in FIGS. 6A-6B and 7 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1324 that specify actions to be taken by that machine. Further, while only a single machine is illustrated, the term “machine” shall also be taken to include any collection of machines that individually or jointly execute instructions 1324 to perform any one or more of the methodologies discussed herein.

The example computer system 1300 includes one or more processors (generally, processor 1302) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1304, and a static memory 1306, which are configured to communicate with each other via a bus 1308. The computer system 1300 may further include graphics display unit 1310 (e.g., a plasma display panel (PDP), a liquid crystal display (LCD), a projector, or a cathode ray tube (CRT)). The computer system 1300 may also include alphanumeric input device 1312 (e.g., a keyboard), a cursor control device 1314 (e.g., a mouse, a trackball, a joystick, a motion sensor, or other pointing instrument), a storage unit 1316, a signal generation device 1318 (e.g., a speaker), and a network interface device 1320, which also are configured to communicate via the bus 1308.

The storage unit 1316 includes a computer-readable medium 1322 on which is stored instructions 1324 embodying any one or more of the methodologies or functions described herein. The instructions 1324 may also reside, completely or at least partially, within the main memory 1304 or within the processor 1302 (e.g., within a processor's cache memory) during execution thereof by the computer system 1300, the main memory 1304 and the processor 1302 also constituting computer-readable media. The instructions 1324 may be transmitted or received over a network 1326 via the network interface device 1320.

While computer-readable medium 1322 is shown in an example aspect to be a single medium, the term “computer-readable medium” should be taken to include a single medium or multiple media (e.g., a centralized or distributed database, or associated caches and servers) able to store instructions (e.g., instructions 1324). The computer-readable medium may include any medium that is capable of storing instructions (e.g., instructions 1324) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### ADDITIONAL CONSIDERATIONS

The foregoing description of the aspects has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some aspects, a software module is implemented with a computer program product comprising one or more computer-readable media storing computer program code or instructions, which can be executed by a computer processor for performing any or all of the steps, operations, or processes described. In some aspects, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Aspects may also relate to a product that is produced by a computing process described herein. Such a product may store information resulting from a computing process, where the information is stored on a non-transitory, tangible computer-readable medium and may include any aspect of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
detecting an environmental condition affecting a high-altitude balloon,
wherein the environmental condition affects a pressure within the high-altitude balloon;
responsive to detecting the environmental condition, determining the pressure changes from an initial pressure to a modified pressure; and
controlling a phase change of a multi-phase ballast gas to change the pressure from the modified pressure to a compensated pressure,
wherein the phase change causes the multi-phase ballast gas to adjust the compensated pressure towards the initial pressure.

2. The method of claim 1, further comprising adjusting an altitude of the high-altitude balloon towards a target altitude by controlling the phase change of the multi-phase ballast gas.

3. The method of claim 2, wherein adjusting the altitude of the high-altitude balloon comprises, responsive to temperature changes, adjusting the altitude of the high-altitude balloon towards the target altitude by controlling the phase change of the multi-phase ballast gas.

4. The method of claim 3, further comprising, responsive to a temperature decrease, causing the phase change to expel the multi-phase ballast gas from a ballast tank to achieve the target altitude.

5. The method of claim 1, wherein the high-altitude balloon includes a first balloon and a second balloon, wherein controlling the phase change of the multi-phase ballast gas comprises controlling the phase change of the multi-phase ballast gas to change the modified pressure in the second balloon.

6. The method of claim 5, wherein the second balloon is within the first balloon.

7. The method of claim 5, wherein the second balloon is outside of the first balloon.

8. The method of claim 1, wherein the high-altitude balloon includes a single balloon, wherein controlling the phase change of the multi-phase ballast gas comprises controlling the phase change of the multi-phase ballast gas to change the modified pressure in the single balloon.

9. The method of claim 1, wherein controlling the phase change comprises extracting the multi-phase ballast gas from the high-altitude balloon.

10. The method of claim 1, wherein controlling the phase change comprises:
measuring a total volume of gas in the high-altitude balloon, wherein the total volume of gas comprises a target volume for the multi-phase ballast gas; and
controlling the multi-phase ballast gas to achieve the target volume being between about 10% and about 25% of the total volume of gas.

11. A high-altitude balloon system configured to maintain an altitude across environmental conditions by controlling phase changes of a multi-phase ballast gas, the high-altitude balloon system comprising:
a balloon, comprising a gas, wherein an environmental condition affecting a pressure of the gas within the balloon; and
a ballast component, fluidically coupled to the balloon, the ballast component comprising:
a tank, coupled to the balloon, the tank comprising the multi-phase ballast gas in a liquid phase;
an environmental sensor, coupled to the tank, configured to measure the environmental condition; and
a controller, coupled to the environmental sensor, the controller configured to:
detect the environmental condition affecting the balloon;
responsive to detecting the environmental condition, determine the pressure changes from an initial pressure to a modified pressure; and
control a phase change of the multi-phase ballast gas to change the pressure from the modified pressure to a compensated pressure, wherein the phase change causes the multi-phase ballast gas to adjust the compensated pressure towards the initial pressure.

12. The high-altitude balloon system of claim 11, wherein the controller is further configured to adjust an altitude of the high-altitude balloon system towards a target altitude by controlling the phase change of the multi-phase ballast gas.

13. The high-altitude balloon system of claim 12, wherein the controller is further configured to, responsive to temperature changes, adjust the altitude of the high-altitude balloon system towards the target altitude by controlling the phase change of the multi-phase ballast gas.

14. The high-altitude balloon system of claim 13, wherein the controller is further configured to, responsive to a temperature decrease, expel the multi-phase ballast gas from the tank to achieve the target altitude.

15. The high-altitude balloon system of claim 11, wherein the balloon includes a first balloon and a second balloon, wherein the controller is further configured to control the phase change of the multi-phase ballast gas to change the modified pressure in the second balloon.

16. The high-altitude balloon system of claim 15, wherein the second balloon is within the first balloon.

17. The high-altitude balloon system of claim 15, wherein the second balloon is outside of the first balloon.

18. The high-altitude balloon system of claim 11, wherein the balloon includes a single balloon, wherein the controller is further configured to control the phase change of the multi-phase ballast gas to change the modified pressure in the single balloon.

19. The high-altitude balloon system of claim 11, wherein the controller is further configured to:
measure a total volume of gas in the balloon, wherein the total volume of gas comprises a target volume for the multi-phase ballast gas; and
control the multi-phase ballast gas to achieve the target volume being between about 10% and about 25% of the total volume of gas.

20. A non-transitory computer-readable medium, storing computer program instructions that, when executed by a processor, cause the processor to:
detect an environmental condition affecting a high-altitude balloon, the environmental condition affecting a pressure within the high-altitude balloon;
responsive to detecting the environmental condition, determine the pressure changes from an initial pressure to a modified pressure; and
control a phase change of a multi-phase ballast gas to change the pressure from the modified pressure to a compensated pressure, wherein the phase change causes the multi-phase ballast gas to adjust the compensated pressure towards the initial pressure.
